(19) United States
(12) Patent Application Publication
(10) Pub. No.: US 2009/0245073 A1
(43) Pub. Date: Oct. 1, 2009

(54) OPTICAL PICKUP APPARATUS

(75) Inventors: Tohru Hotta, Nagano (JP); Ryoichi Kawasaki, Gunma (JP)

Correspondence Address: FISH & RICHARDSON P.C., P.O. BOX 1022, MINNEAPOLIS, MN, 55440-1022, US

(73) Assignees: Sanyo Electric Co., Ltd., Osaka (JP); Sanyo Optec Design Co., Ltd., Tokyo (JP)

(21) Appl. No.: 12/413,151

(22) Filed: Mar. 27, 2009

(30) Foreign Application Priority Data
Mar. 28, 2008 (JP) 2008-085826

(51) Int. Cl. G11B 7/135

(52) U.S. Cl. 369/112.24; G9B/7.112

(57) ABSTRACT

An optical-pickup apparatus comprising: a laser diode; an objective lens made of a synthetic resin to focus laser light emitted from the laser diode onto a signal-recording layer of an optical disc; a collimating lens that is arranged in an optical path between the laser diode and the objective lens, and is so movable in an optical axis direction of the laser light as to correct spherical aberration; a temperature sensor to detect a temperature of the objective lens; and an aberration-correcting device to move the collimating lens from a first position where the spherical aberration is a predetermined value on a positive side to a second position where the spherical aberration is a predetermined value on a negative side, when an amount of change in temperature detected by the temperature sensor reaches a predetermined amount after an operation of reproducing a signal from the signal-recording layer is started.

### CROSS-REFERENCE TO RELATED APPLICATION

This application claims the benefit of priority to Japanese Patent Application No. 2008-085826, filed Mar. 28, 2008, of which full contents are incorporated herein by reference.

### BACKGROUND OF THE INVENTION

1. Field of the Invention

The present invention relates to an optical pickup apparatus that executes an operation of reading a signal recorded in an optical disc or an operation of recording a signal in the optical disc with laser light.

2. Description of the Related Art

Optical disc devices has been widespread each of which is capable of a signal reading operation and signal recording operation by applying laser light emitted from an optical pickup apparatus to a signal recording layer of the optical disc.

The optical disc devices using optical discs called CDs or DVDs are available in general, however, optical discs whose recording densities are improved, that is, those using Blu-ray standard optical discs have recently been developed.

Infrared light with a wavelength of 780 nm is used as the laser light executing the operation of reading a signal recorded in a CD standard optical disc, and red light with a wavelength of 650 nm is used as the laser light executing the operation of reading a signal recorded in a DVD standard optical disc.

In contrast to cases of such CD-standard and DVD-standard optical discs, laser light with a short wavelength, or a blue-violet light with a wavelength of 405 nm, for example, is used as the laser light executing the operation of reading a signal recorded in a Blu-ray standard optical disc.

The thickness is 0.1 mm of a protective layer provided on an upper surface of the signal recording layer in the Blu-ray standard optical disc, and the numerical aperture is specified at 0.85 of an objective lens used for the operation of reading a signal from this signal recording layer.

For such an optical pickup apparatus compliant with the optical disc standard with improved recording density, strict optical characteristics are required to perform signal recording/reproducing operation in accordance with improvement in the recording density.

If glass is used as material of an objective lens for focusing the laser light onto the signal recording layer included in the optical disc, since it is not affected by temperature, signal recording characteristics and signal reproducing characteristics can be improved, however, there is a problem of high cost. As a method for solving such a problem, a method is generally performed of manufacturing an objective lens by injection-molding a synthetic resin.

Although the objective lens made of the synthetic resin has an advantage of being able to be manufactured less expensively as well as be reduced in weight, the lens expands or contracts with changes in temperature, and thus spherical aberration occurs, which causes a problem that a signal reading characteristic is deteriorated. As a method of correcting the spherical aberration occurring in the objective lens, there is employed in many cases a method of moving a collimating lens provided in an optical path between a laser diode and the objective lens in the optical axis direction (See Japanese Patent Laid-Open Publication No. 2003-132573).

FIG. 7 shows a relationship between a change in temperature of the objective lens and a spherical aberration amount, which is in a relationship that the spherical aberration amount is increased with rise in the temperature. If the temperature of the objective lens rises, the spherical aberration amount is increased, as shown in FIG. 7. Thus in some recent optical pickup apparatuses, there may be included a temperature sensor for detecting the temperature of the objective lens so that the spherical aberration is corrected by moving the collimating lens in the optical axis direction when the temperature of the objective lens is raised by predetermined degrees.

FIG. 8 is a diagram for explaining a control operation for correcting the spherical aberration in the optical pickup apparatus and description will be made referring to FIG. 8. At to, the spherical aberration amount is zero, and a signal reading operation and the like of the optical pickup apparatus is started.

When the signal reading operation is started, heat is generated from a laser driving circuit for supplying a driving signal to a laser diode provided so as to emit laser light, a laser diode, a focusing coil for moving the objective lens in a direction perpendicular to an optical disc surface, a tracking coil for moving the objective lens in the radial direction of the optical disc, and the like, and thus, the temperature of the objective lens is raised by such heat.

If the temperature of the objective lens is raised, the spherical aberration amount is gradually increased as shown. If the temperature is raised from t0 to t1, the spherical aberration amount is increased to a magnitude indicated by P. The change in temperature from t0 to t1 is set at 5° C., for example, and the spherical aberration amount represented by P is set on the basis of such an amount as not to interfere with the signal reading operation of the optical pickup apparatus, that is, an allowable amount.

Such a relationship between the rise in temperature and the spherical aberration amount is set in advance, and if the rise in temperature to t1 is detected on the basis of a signal obtained from the temperature sensor, an operation is performed of moving the collimating lens provided for correcting the spherical aberration by an amount set in advance.

Such an operation of moving the collimating lens is, as is known from FIG. 8, carried out so as to move the collimating lens to a position at which the spherical aberration amount becomes zero. The spherical aberration amount is corrected to become zero by the above collimating lens moving operation, however, if the signal reading operation is continued in such a state, the temperature of the objective lens is further raised.

If the temperature of the objective lens is raised from t1 to t2 with the signal reading operation being continued, the spherical aberration amount is also increased to the magnitude indicated by P. However, in this case as well, the collimating lens moving operation is carried out on the basis of the temperature detection operation, so that the correction operation is carried out to reduce the spherical aberration amount to zero. By repeating the collimating lens moving operation, an operation is performed of correcting the spherical aberration increased with the rise in temperature of the objective lens.

The moving control operation of the collimating lens is performed on the basis of the detection of the temperature of the objective lens, as above, however, the magnitude of the spherical aberration, at which the collimating lens moving operation is carried out, that is, the amount indicated by P is set on the basis of an allowable value, at which the optical pickup apparatus can perform the reading operation without trouble.

Each value is set from the relationship between the amount of change in temperature and the spherical aberration amount at a time when the collimating lens starts being moved. However, if the spherical aberration amount is increased to become closer to the allowable value, a range of the detected temperature to be raised becomes wide, so that the control operation based on the temperature is facilitated. However, the range of the spherical aberration amount to be increased becomes wider, and thus, the signal reading characteristics might be affected under an influence of variously changing rotation characteristics of the optical disc, and the like.

In order to avoid such a problem, if the magnitude of the spherical aberration amount is decreased to become far from the allowable value, the range of the detected temperature to be raised becomes narrow, and thus, not only can the temperature detection operation not easily be performed, but also the collimating lens moving operation is frequently carried out, which is a problem.

### SUMMARY OF THE INVENTION

An optical pickup apparatus according to an aspect of the present invention, comprises: a laser diode; an objective lens made of a synthetic resin configured to focus laser light emitted from the laser diode onto a signal recording layer of an optical disc; a collimating lens arranged in an optical path between the laser diode and the objective lens, the collimating lens being so movable in an optical axis direction of the laser light as to correct spherical aberration; a temperature sensor configured to detect a temperature of the objective lens; and an aberration correcting device configured to move the collimating lens from a first position at which the spherical aberration is a predetermined value on a positive side to a second position at which the spherical aberration is a predetermined value on a negative side, when an amount of change in temperature detected by the temperature sensor reaches a predetermined amount after an operation of reproducing a signal from the signal recording layer of the optical disc is started.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a diagram illustrating an optical pickup apparatus according to an embodiment of the present invention;

FIG. 2 is a flowchart for describing an operation of the optical pickup apparatus according to an embodiment of the present invention;

FIG. 3 is a flowchart for describing an operation of the optical pickup apparatus according to an embodiment of the present invention;

FIG. 4 is a diagram for describing an operation of the optical pickup apparatus according to an embodiment of the present invention;

FIG. 5 is a diagram for describing an operation of the optical pickup apparatus according to an embodiment of the present invention;

FIG. 6 is a diagram for describing an operation of the optical pickup apparatus according to an embodiment of the present invention;

FIG. 7 is a characteristic diagram illustrating a relationship between a spherical aberration and temperature; and

FIG. 8 is a diagram for describing an operation of the optical pickup apparatus.

### DETAILED DESCRIPTION OF THE INVENTION

At least the following details will become apparent from descriptions of this specification and of the accompanying drawings.

In an optical pickup apparatus according to an embodiment of the present invention, laser light emitted from a laser diode is guided to an objective lens made of a synthetic resin, so that the laser light is focused by a focusing operation of the objective lens onto a signal recording layer included in an optical disc so as to carry out a signal reading operation, a spherical aberration is corrected by moving a collimating lens provided in an optical path between the laser diode and the objective lens in an optical axis direction, and a temperature sensor for detecting a temperature of the objective lens is provided; and thus, the collimating lens is moved from a first position at which a spherical aberration amount is a predetermined amount on a positive side to a second position at which the spherical aberration amount is a predetermined amount on a negative side, when an amount of change in the temperature detected by the temperature sensor after the signal reading is started reaches a predetermined value. The positive and negative signs of the spherical aberration amount indicate that directions in which the spherical aberration occurs are opposite from each other, wherein the negative sign thereof indicates overcorrection of the spherical aberration, and the positive sign thereof indicates insufficient correction of the spherical aberration.

In the optical pickup apparatus according to an embodiment of the present invention, a moving amount of the collimating lens is set such that the spherical aberration amount at a first position and the spherical aberration amount at a second position are equal in absolute value.

In the optical pickup apparatus according to an embodiment of the present invention, the collimating lens is moved to an operation start position at which the spherical aberration amount is zero, before a signal reading operation is started.

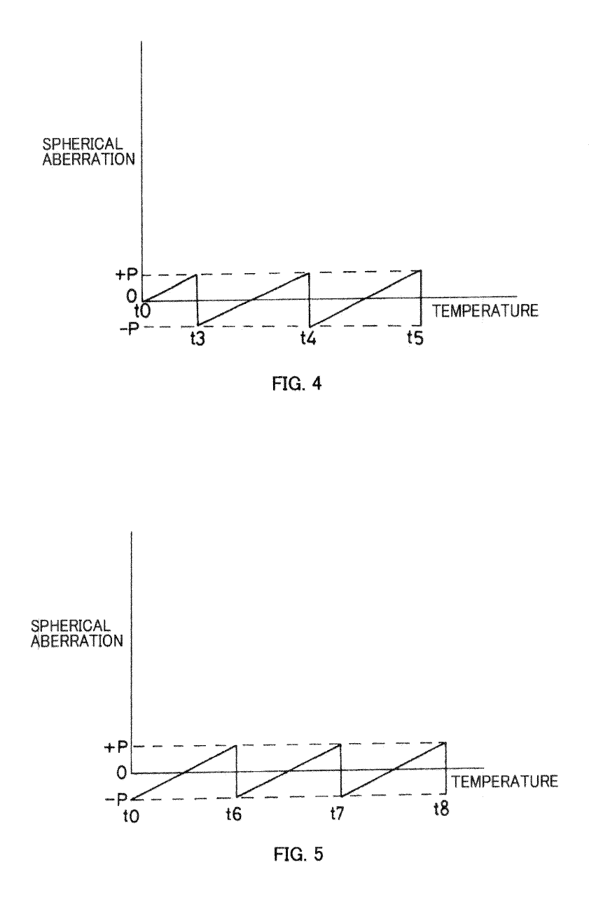

In the optical pickup apparatus according to an embodiment of the present invention, an amount (t0-t3 in FIG. 4) of change in temperature when the first movement operation of the collimating lens is carried out subsequent to starting the signal reading operation is set to half of a predetermined value which is set as an amount (t3-t4 or t4-t5 in FIG. 4) of change in temperature.

In the optical pickup apparatus according to an embodiment of the present invention, the collimating lens is moved to the operation start position at which the spherical aberration amount becomes a negative amount, before the signal reading operation is started.

In the optical pickup apparatus according to an embodiment of the present invention, a spherical aberration amount set as the operation start position is equal to the spherical aberration amount set as the second position.

In the optical pickup apparatus according to an embodiment of the present invention, the operation start position of the collimating lens is determined through detection of a jitter value obtained from a signal read from the optical disc.

In the optical pickup apparatus according to an embodiment of the present invention, the operation start position of the collimating lens is determined through detection of an RF signal read from the optical disc.

In the optical pickup apparatus according to an embodiment of the present invention, the temperature sensor for detecting the temperature of the objective lens is included, and the collimating lens, which is provided so as to correct the spherical aberration when the amount of change in the temperature detected by the temperature sensor reaches the predetermined amount after the signal reading operation is started, is moved from the first position at which the spherical aberration amount is the predetermined amount on the positive side to the second position at which the spherical aberration amount is the predetermined amount on the negative side, that is, an operation of correcting the change in the spherical aberration amount is carried out in a range between the predetermined amount on the negative side and the predetermined amount on the positive side, and thus, in a range therebetween, there exists a state where the spherical aberration amount is zero.

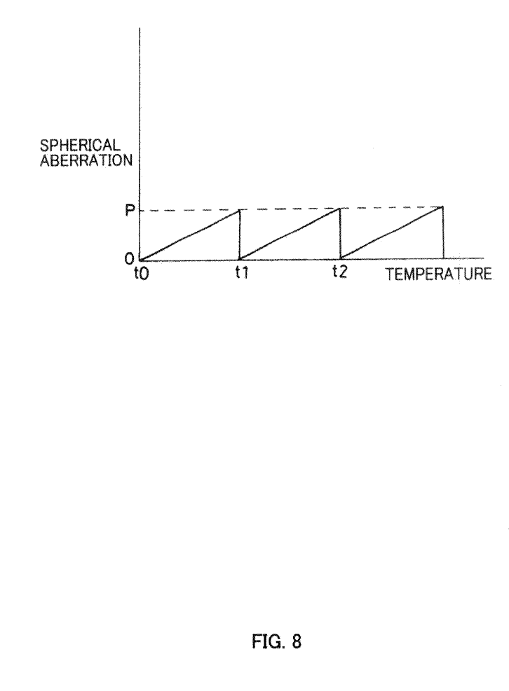

That is, in the optical pickup apparatus according to an embodiment of the present invention, since a range of a correction amount of the spherical aberration is set between the predetermined amount on the negative side and the predetermined amount on the positive side, even if the correction amount range is the same as that described in FIG. 8, the spherical aberration amount on the positive side and the spherical aberration amount on the negative side can be reduced. Therefore, according to an embodiment of the present invention, the spherical aberration amount, for which the correction operation is carried out through the detection of the temperature, can be reduced to become far from an allowable value, and thus, the characteristics as the optical pickup apparatus can be ensured.

In the optical pickup apparatus according to an embodiment of the present invention, the operation of correcting the spherical aberration with the collimating lens is carried out around the position at which the spherical aberration amount is zero, and accordingly, an average spherical aberration amount can be rendered zero. Therefore, the characteristics of the optical pickup apparatus including the objective lens made of the synthetic resin can be improved.

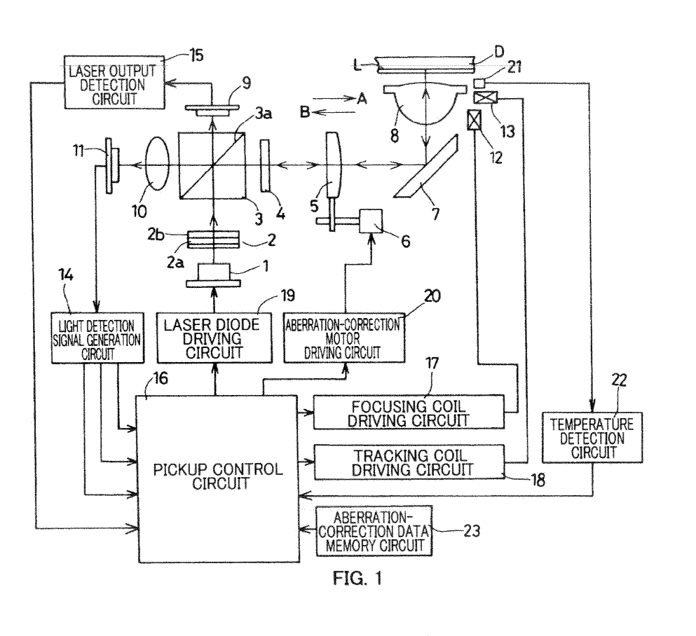

In FIG. 1, a laser diode 1 emits laser light forward, which is blue-violet light with a wavelength of 405 nm, for example the laser light emitted from the laser diode 1 enters a diffraction grating 2 and the diffraction grating 2 includes a diffraction grating portion 2a that divides the laser light into a main beam, which is 0th order light, and two sub beams, which are +1st order diffracted light and −1st order diffracted light, and a half-wave plate 2b that converts the incident laser light into a linearly polarized light in an S direction, for example.

The laser light having passed through the diffraction grating 2 enters a polarization beam splitter 3, and the polarization beam splitter 3 includes a control film 3a that reflects most of the S-polarized laser light, allows a part of the laser light to be allowed to pass therethrough, and allows the laser light converted into a linearly polarized light in a P direction to pass therethrough.

A quarter-wave plate 4 is provided at a position where the laser light reflected by the control film 3a of the polarization beam splitter 3 is incident and the quarter-wave plate 4 converts the incident laser light from linearly polarized light to circularly polarized light, or to the contrary, from the circularly polarized light to the linearly polarized light. The laser light having passed through the quarter-wave plate 4 enters a collimating lens 5, and the collimating lens 5 converts the incident laser light into parallel light and is capable of moving by an aberration correction motor 6 in an optical axis direction, that is, directions of arrows A and B. A spherical aberration is corrected with a movement operation of the collimating lens 5 in the optical axis direction.

A raising mirror 7 is provided at a position where the laser light having passed through the collimating lens 5 is incident and the raising mirror 7 reflects the incident laser light in a direction of the objective lens 8 made of a synthetic resin. A front monitor photodetector 9 is provided at a position where the laser light having passed through the control film 3a included in the polarization beam splitter 3 is applied, and outputs a signal according to a level of the applied laser light as a monitor signal.

In a configuration as above, the laser beam emitted from the laser diode 1 is made incident on the objective lens 8 through the diffraction grating 2, the polarization beam splitter 3, the quarter-wave plate 4, the collimating lens 5, and the raising mirror 7, and then, such incident light is applied as a spot on a signal recording layer L of an optical disc D by a focusing operation of the objective lens 8, and the laser light applied to the signal recording layer L is reflected as return light.

The return light reflected from the signal recording layer L of the optical disc D is incident on the control film 3a of the polarization beam splitter 3 through the objective lens 8, the raising mirror 7, the collimating lens 5, and the quarter-wave plate 4. Since the return light incident on the control film 3a of the polarization beam splitter 3 as above has been converted into the linearly polarized light in the P direction by a phase change operation of the quarter-wave plate 4, the return light is not reflected by the control film 3a but is allowed to pass therethrough as control laser light.

The control laser light having passed through the control film 3a of the polarization beam splitter 3 enters a sensor lens 10 and the sensor lens 10 adds astigmatism to the control laser light to be applied to a light-receiving portion included in a photodetector 11 called PDIC. In the photodetector 11, a known four-divided sensor, etc., are included and the photodetector 11 is made up so as to perform a signal generation operation accompanied by an operation of reading a signal recorded in the signal recording layer L of the optical disc D by an application operation of the main beam, an operation of generating a signal for performing a focusing control operation by an astigmatic method, and an operation of generating a signal for performing a tracking control operation by an application operations of the two sub beams.

An optical system of the optical pickup apparatus according to an embodiment of the present invention is configured as mentioned above, and in such a configuration, the objective lens 8 is fixed to a lens holding frame (not shown) supported by four or six support wires on a base (not shown) included in the optical pickup apparatus so that movement operations can be performed in a perpendicular direction relative to a signal surface of the optical disc D, i.e., a focusing direction, and in a radial direction of the optical disc D, i.e., a tracking direction.

A focusing coil 12 is provided at the lens holding frame to which the objective lens 8 is fixed, and moves the objective lens 8 in the focusing direction in cooperation with a magnet (not shown) fixed to the base. A tracking coil 13 is provided at the lens holding frame to which the objective lens 8 is fixed, and moves the objective lens 8 in the tracking direction in cooperation with a magnet (not shown) fixed to the base.

A light detection signal generation circuit 14 generates: an RF signal, which is a signal obtained with the operation of reading a signal recorded in the signal recording layer of the optical disc D from a sensor making up the photodetector 11 and receiving the main beam; a focus error signal, which is a signal obtained from the sensor receiving the main beam with the focusing operation of the laser light; and a tracking error signal, which is a signal obtained from sensors receiving the sub beams with the tracking operation of the laser light.

A signal obtained from the front monitor photodetector 9 is input to a laser output detection circuit 15 and the laser output detection circuit 15 outputs a signal according to a level of the input signal as a monitor signal.

Various signals output from the light detection signal generation circuit 14 and the laser output detection circuit 15 and the like are input to a pickup control circuit 16 and the pickup control circuit 16 performs various control operations of the optical pickup apparatus on the basis of each of the signals. A focus control signal output from the pickup control circuit 16 on the basis of the focus error signal generated to be output from the light detection signal generation circuit 14, is input to a focusing coil driving circuit 17, and the focusing coil driving circuit 17 supplies a driving signal to the focusing coil 12. A tracking control signal output from the pickup control circuit 16 on the basis of the tracking error signal generated to be output from the light detection signal generation circuit 14, is input to a tracking coil driving circuit 18, and the tracking coil driving circuit 18 supplies a driving signal to the tracking coil 13.

A laser diode driving circuit 19 supplies a driving signal to the laser diode 1 and the laser diode driving circuit 19 adjusts a laser output with a control signal output from the pickup control circuit 16 on the basis of a monitor signal obtained from the laser output detection circuit 15. An aberration-correction motor driving circuit 20 corrects a spherical aberration by supplying a driving signal to the aberration correction motor 6 to move the collimating lens 5 in the optical axis direction, and is controlled by the pickup control circuit 16.

A temperature sensor 21 is provided in proximity to the objective lens 8 so as to detect temperature of the objective lens 8. A temperature detection circuit 22 detects the temperature on the basis of a signal obtained from the temperature sensor 21 and outputs a detection signal to the pickup control circuit 16. An aberration-correction data memory circuit 23 stores various data for carrying out a spherical aberration correction operation, which will be described later, and a data reading operation and the like are controlled by the pickup control circuit 16.

The optical pickup apparatus according to an embodiment of the present invention is configured as mentioned above, and an operation thereof will hereinafter be described.

When the operation is performed of reading a signal recorded in the signal recording layer L included in the optical disc D, a driving control signal is supplied from the pickup control circuit 16 to each of the circuits making up the optical pickup apparatus. A driving signal for obtaining the laser output set in advance for performing an accurate signal reading operation is supplied from the laser diode driving circuit 19 to the laser diode 1, so that the laser light with a desired output is emitted from the laser diode 1.

The laser light emitted from the laser diode 1 enters the diffraction grating 2, to be divided into the main beam and the sub beams by the diffraction grating portion 2a included in the diffraction grating 2, and to be converted into the linearly polarized light in the S direction by the half-wave plate 2b. The laser light having passed through the diffraction grating 2 enters the polarization beam splitter 3, and most of the laser light is reflected by the control film 3a included in the polarization beam splitter 3, while a part of the laser light is allowed to pass therethrough.

The laser light reflected by the control film 3a included in the polarization beam splitter 3 enters the quarter-wave plate 4 to be converted from the linearly polarized light into the circularly polarized light, and then, enters the collimating lens 5. The laser light incident on the collimating lens 5 is converted into the parallel light, to made incident on the raising mirror 7.

The laser light incident on the raising mirror 7 is reflected by the raising mirror 7 in a direction of the objective lens 8. The laser light reflected by the raising mirror 7 enters the objective lens 8, and the focusing operation by the objective lens 8 is performed.

The focusing operation of the laser light onto the signal recording layer L by the objective lens 8 is carried out by performing an operation to move the objective lens 8 closer to the optical disc D from a position away from the optical disc D, for example. Such an operation of moving the objective lens 8 is carried out by supplying the driving signal from the focusing coil driving circuit 17 to the focusing coil 12, and when the focusing operation onto the signal recording layer L is carried out, the laser light reflected by the signal recording layer L enters the objective lens 8 from the side of the optical disc D as the return light.

The return light incident on the objective lens 8 enters the control film 3a included in the polarization beam splitter 3 through the raising mirror 7, the collimating lens 5, and the quarter-wave plate 4. Since the return light incident on the control film 3a has been converted by the quarter-wave plate 4 into the linearly polarized light in the P direction, the light is not reflected by the control film 3a but all the light is allowed to pass there through as control laser light.

The control laser light which is the return light having passed through the control film 3a enters the sensor lens 10, and then, is added with astigmatism by the sensor lens 10 to be applied to a sensor portion included in the photodetector 11. As the result of irradiation of the control laser light to the photodetector 11, a detection signal can be obtained on the basis of a position and change in shape of applied spot of the main beam, from the four-divided sensor, which is the light receiving portion for the main beam, and the like included in the photodetector 11, and similarly, a detection signal can be obtained on the basis of positions and changes in shapes of applied spots of the sub beams, from the four-divided sensors, which are the respective light receiving portions for the sub beams, and the like included in the photodetector 11.

In such a state, the focus error signal and the tracking error signal generated from the light detection signal generation circuit 14 on the basis of the detection signal obtained from the photodetector 11 are input to the pickup control circuit 16. When the focus error signal and tracking error signal are input to the pickup control circuit 16, control signals on the basis of the error signals are respectively output to the focusing coil driving circuit 17 and the tracking coil driving circuit 18. As a result, since a control signal is supplied to the focusing coil 12 from the focusing coil driving circuit 17, the operation of moving the objective lens 8 is carried out in the focusing direction with the focusing coil 12, so that the focusing control operation can be performed of focusing the laser light onto the signal recording layer L. Since a control signal is supplied to the tracking coil 13 from the tracking coil driving circuit 18, the operation of moving the objective lens 8 is carried out in the tracking direction with the tracking coil 13, so that the tracking control operation can be performed of making the laser light follow a signal track provided in the signal recording layer L.

Since the focusing control operation and the tracking control operation are carried out in the optical pickup apparatus as mentioned above, the operation can be performed of reading a signal recorded in the signal recording layer L of the optical disc D. A reproduction signal obtained by such a reading operation can be obtained as information data by demodulating an RF signal generated from the light detection signal generation circuit 14 in a known way.

The operation is performed of reading a signal recorded in the signal recording layer L included in the optical disc D as mentioned above, and in a state of performing such a reading operation, the collimating lens 5 provided as a aberration correcting element is made up to be movable in the optical direction so as to correct the spherical aberration with respect to the signal recording layer L by a driving signal supplied to the aberration correction motor 6 from the aberration-correction motor driving circuit 20.

By correcting spherical aberration by the movement operation of the collimating lens 5 as mentioned above, the operation can be performed of reading a signal recorded in the signal recording layer L included in the optical disc D in an optimal state.

While the above-mentioned signal reading operation is performed, a driving signal, by which a desired laser output can be obtained, is supplied to the laser diode 1 from the laser diode driving circuit 19 and a monitor signal output from the laser output detection circuit 15 on the basis of a signal obtained from the front monitor photodetector 9 is input to the pickup control circuit 16.

When the monitor signal output from the laser output detection circuit 15 is input to the pickup control circuit 16 as above, a control signal on the basis of a level of the monitor signal is supplied to the laser diode driving circuit 19 from the pickup control circuit 16. Therefore, if control is performed such that a level of a driving signal supplied to the laser diode driving circuit 19 from the pickup control circuit 16 becomes a predetermined value, an output of the laser light emitted from the laser diode 1 can be automatically controlled so as to become a desired level.

As mentioned above, the laser light emitted from the laser diode 1 enters the objective lens 8 through an optical path formed with the diffraction grating 2, the polarization beam splitter 3, the quarter-wave plate 4, the collimating lens 5, and the raising mirror 7, to be applied to the signal recording layer L of the optical disc D as a desired spot by the focusing operation with the objective lens B.

The laser light applied to the signal recording layer L of the optical disc D by the above-mentioned operation is reflected by the signal recording layer L. The return light, which is the laser light reflected from the signal recording layer L as above, is applied to the photodetector 11 as the control laser light through the optical path including the objective lens 8, the raising mirror 7, the collimating lens 5, the quarter-wave plate 4, the polarization beam splitter 3, and the sensor lens 10.

When the control laser light is applied to the photodetector 11 as above, the above-mentioned various signals are obtained from the photodetector 11, and thus, by using such signals, the operation of reading a signal, the focusing control operation, and the tracking control operation can normally be performed in the optical pickup apparatus.

When the signal reading operation is carried out by the optical pickup apparatus, heat is generated from the circuits, etc., with an operation of supplying a driving signal from the laser diode driving circuit 19 to the laser diode 1, an operation of supplying a driving signal from the focusing coil driving circuit 17 to the focusing coil 12, and an operation of supplying a driving signal from the tracking coil driving circuit 18 to the tracking coil 13, and thus, temperature of the inside of the optical pickup apparatus, that is, an environmental temperature is raised.

The objective lens 8 made of the synthetic resin has such properties that as the environmental temperature is raised, the lens is raised in temperature to be expanded and deformed, resulting in changes in focusing characteristics thereof. When the focusing characteristics of the objective lens 8 are changed, the spherical aberration occurs, and thus, the focusing characteristics of the laser light to the signal recording layer L are deteriorated.

In an embodiment according to the present invention, the spherical aberration is corrected which is caused by the rise in temperature of the objective lens 8, and an aberration correction operation with the use of the temperature sensor 21 will be described.

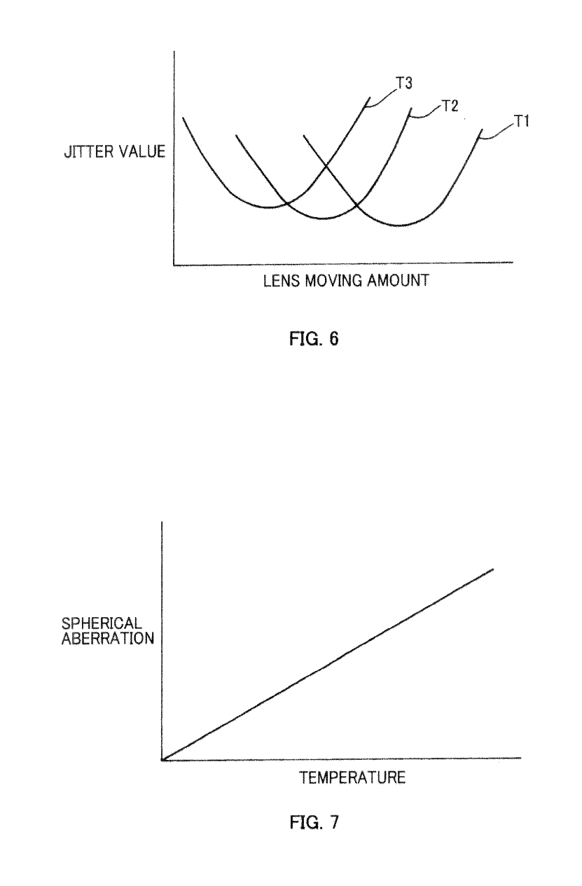

An operation of correcting the spherical aberration in the optical pickup apparatus according to an embodiment of the present invention is carried out by the movement operation of the collimating lens 5 by the aberration correction motor 6, and a relationship among the temperature of the objective lens 8, a moving amount of the collimating lens 5, and a jitter value will be described referring to FIG. 6.

The jitter value can be detected and obtained from the RF signal generated in the optical detection signal generation circuit 14. In FIG. 6, characteristics indicated by T1, T2, and T3 show a relationship between the moving amount of the collimating lens 5 and the jitter value at different temperatures of the objective lens 8. As is obvious from such a characteristic diagram, the moving amount of the collimating lens 5 and the jitter value are changed as a quadratic function of each other. Therefore, by obtaining data at several points from a quadratic function expression corresponding to the detected temperature, the moving amount of the collimating lens 5, with which the jitter value becomes the minimum, can be determined.

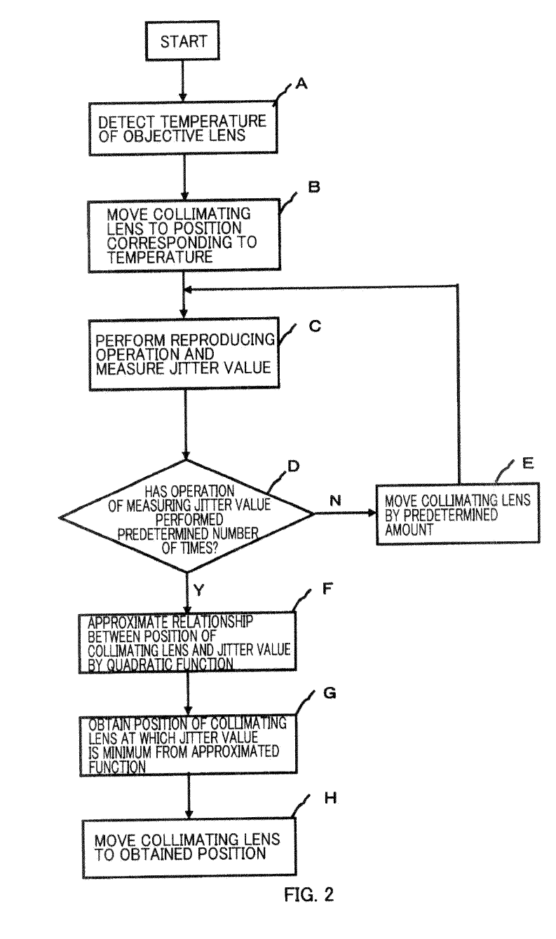

An operation of moving the collimating lens 5 to a desired position before the signal reading operation is started will be described referring to a flowchart shown in FIG. 2. First, an operation of detecting the temperature of the objective lens 8 is carried out (Step A). Such a temperature detection operation is carried out by a detection operation by the temperature detection circuit 22 on the basis of a detection signal obtained from the temperature sensor 21 provided in proximity to the objective lens 8.

When the temperature detected by the temperature detection operation by the temperature detection circuit 22 is input to the pickup control circuit 16, the moving amount set in advance corresponding to the detected temperature is read out of the aberration-correction data memory circuit 23, and the collimating lens 5 is moved to a position corresponding to the temperature (Step B).

When the operation of moving the collimating lens 5 is carried out, an operation of measuring the jitter value included in a signal reproduced by a reproducing operation is carried out (Step C). When the operation of measuring the jitter value is carried out, it is determined whether or not the measurement operation has been carried out a predetermined number of times (Step D). If it is determined that the jitter-value measurement operation has not been carried out the predetermined number of times, an operation of moving the collimating lens 5 by a predetermined amount is carried out by rotating the aberration correction motor 6 for a predetermined times (Step E).

When the operation of Step E has been carried out, the jitter-value measurement operation is carried out by returning to step C, and when it is determined at Step D that the jitter-value measurement operation has been carried out the predetermined number of times, an operation of approximating the relationship between a position of the collimating lens 5 and the jitter value by the quadratic function (Step F). When the quadratic function indicating the relationship between the position of the collimating lens 5 and the jitter value is approximated, the position of the collimating lens 5 at which the jitter value becomes the minimum, that is, the moving amount is obtained from the approximated function (Step G).

When the moving amount of the collimating lens 5 is obtained at Step G, the aberration correction motor 6 is and driven to rotate so as to carry out an operation to move the collimating lens 5 to the desired position on the basis of the obtained moving amount (Step H).

By carrying out such an operation, the collimating lens 5 can be moved to a position at which the spherical aberration is less, such as a position at which the spherical aberration is zero, and thus, the signal reading operation can be started in a state where the spherical aberration is the minimum with respect to the detected temperature.

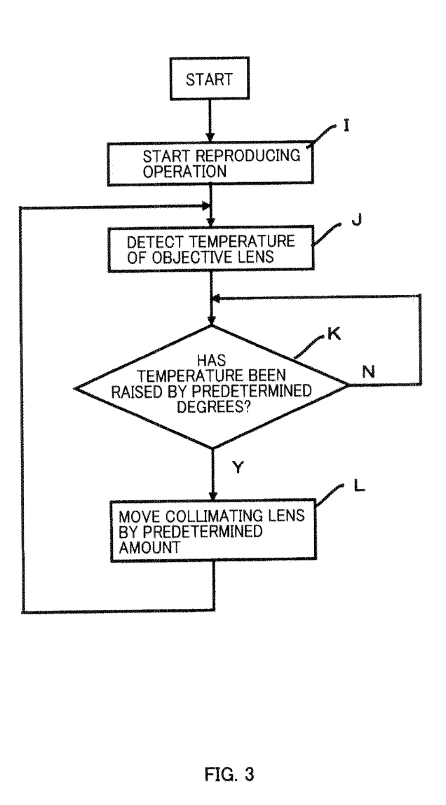

The operation of moving the collimating lens 5 to the desired position is carried out before the operation of reading a signal recorded in the optical disc D as mentioned above, and the operation of correcting the spherical aberration during the signal reading operation will hereinafter be described below referring to a flowchart shown in FIG. 3.

After the above-mentioned operation of moving the collimating lens 5 to the desired position, the reproducing operation is started in the optical disc device (Step I). When the reproducing operation is started, an operation of detecting the temperature of the objective lens 8 is carried out (Step J). Such a temperature detection operation is carried out by the temperature sensor 21 and the temperature detection circuit 22, and the detected temperature is in such a state as to be input to the pickup control circuit 16.

In a state where such a temperature detection operation is carried out, it is determined whether or not the detected temperature has been raised by predetermined degrees (Step K). If it is determined at Step K that the temperature has been raised by predetermined degrees, the operation of moving the collimating lens 5 by a predetermined amount is carried out (Step L). Such an operation of moving the collimating lens 5 is carried out in order to correct the spherical aberration increasing with the rise in temperature of the objective lens 8, and thus, the signal reproducing operation can be carried out without trouble.

The operation of moving the collimating lens 5 in order to correct the spherical aberration increasing with the rise in temperature of the objective lens 8 is carried out as mentioned above, and a movement control operation of the collimating lens 5 according to an embodiment of the present invention will hereinafter be described referring to FIG. 4.

In FIG. 4, t0 is a state when the reproducing operation is started at Step I, and as the reproducing operation is carried out, the temperature is raised from t0 with in crease in the spherical aberration amount. When the temperature is raised from t0 to t3, the spherical aberration is increased to an amount indicated by plus P, and at this point of time, the operation of moving the collimating lens 5 by a predetermined amount is carried out.

The operation of correcting the spherical aberration amount is carried out by such an operation of moving the collimating lens 5, however, in an embodiment of the present invention, the operation of correcting the spherical aberration amount is carried out so that the spherical aberration amount becomes not zero but minus P. The temperature is raised after such a correction operation, and when the temperature has been raised from t3 to t4, the operation of moving the collimating lens 5 is carried out again so that the spherical aberration becomes minus P from plus P. Thereafter, the above-mentioned operation of moving the collimating lens 5 for aberration correction is repeated with the rise in temperature of the objective lens 8.

The control operation is carried out for correcting the spherical aberration in the optical pickup apparatus according to an embodiment of the present invention as above, and as is obvious from FIG. 4, the operation of correcting the spherical aberration is carried out in a range between minus P and plus P. Therefore, even if a correction amount from 0 to plus P, which is an aberration correction range shown in FIG. 8, is equal to a correction amount from minus P to plus P, which is an aberration correction range of an embodiment of the present invention, an amount of the spherical aberration changing from 0 can be reduced in an embodiment according to the present invention, and thus, the reading characteristics, etc., of the optical pickup apparatus can be improved.

As obvious form FIG. 4, since the spherical aberration amount is set to zero at a point of time when the signal reproducing operation is started, the amount of change in temperature from t0 when the signal reproducing operation is started to t3 when the first operation for aberration correction is carried out, is half of the amount of change in temperature from t3 to t4. Therefore, the detection temperature with respect to the first temperature change is set so as to become half.

Another embodiment will be described referring to FIG. 5. As is obvious from FIG. 5, the collimating lens 5 is set at a position at which the spherical aberration of minus P occurs, at the point of time when the reproducing operation is started. According to such a configuration, the amount of change in temperature when the reproducing operation is started, that is, the amount of change in temperature from t0 to t6, can be made equal to the amount of change in temperature from t6 to t7.

As described above, the operation is carried out of moving the collimating lens 5 from a first position at which the spherical aberration amount is a predetermined amount on the positive side to a second position at which the spherical aberration amount is a predetermined amount on the negative side, and thus, an average of the spherical aberration amount can be made zero. Although the predetermined amount on the positive side and the predetermined amount on the negative side are made equal in absolute value, they are not necessarily required to be equal.

Moreover, in an embodiment of the present invention, a configuration is made such that an operation start position of the collimating lens 5 is set through detection of the jitter value, however, a configuration may also be made such that a level of the RF signal is detected, and the operation start position of the collimating lens 5 is set on the basis of a position at which the level becomes the maximum. Furthermore, if a stepping motor is used as the aberration correction motor for moving the collimating lens 5, the amount of rotation can accurately be controlled by the number of driving pulses, and thus, the movement control operation of the collimate lens 5 can accurately be carried out.

The movement control operation of the collimating lens 5 for aberration correction is carried out as above, and a configuration is made such that data for performing the operation, such as data corresponding to each temperature, for example, is stored in the aberration-correction data memory circuit 23, and that an operation of reading required data from the aberration-correction data memory circuit 23 is performed.

The above embodiments of the present invention are simply for facilitating the understanding of the present invention and are not in any way to be construed as limiting the present invention. The present invention may variously be changed or altered without departing from its spirit and encompass equivalents thereof.

What is claimed is:

1. An optical pickup apparatus comprising:
a laser diode;
an objective lens made of a synthetic resin configured to focus laser light emitted from the laser diode onto a signal recording layer of an optical disc;
a collimating lens arranged in an optical path between the laser diode and the objective lens, the collimating lens being so movable in an optical axis direction of the laser light as to correct spherical aberration;
a temperature sensor configured to detect a temperature of the objective lens; and
an aberration correcting device configured to move the collimating lens from a first position at which the spherical aberration is a predetermined value on a positive side to a second position at which the spherical aberration is a predetermined value on a negative side, when an amount of change in temperature detected by the temperature sensor reaches a predetermined amount after an operation of reproducing a signal from the signal recording layer of the optical disc is started.

2. The optical pickup apparatus according to claim 1, wherein
an absolute value of the spherical aberration at the first position is equal to an absolute value of the spherical aberration at the second position.

3. The optical pickup apparatus according to claim 1, wherein
the aberration correcting device moves the collimating lens to an operation start position at which the spherical aberration is zero, before the operation of reproducing a signal from the signal recording layer of the optical disc is started.

4. The optical pickup apparatus according to claim 3, wherein
the amount of change in the detected temperature when the collimating lens is moved from the first position to the second position at a first time after the operation of reproducing a signal from the signal recording layer of the optical disc is started, is set to half of the predetermined amount.

5. The optical pickup apparatus according to claim 1, wherein
the aberration correcting device moves the collimating lens to an operation start position at which the spherical aberration is the predetermined value on the negative side, before the operation of reproducing a signal from the signal recording layer of the optical disc is started.

6. The optical pickup apparatus according to claim 5, wherein
the operation start position at which the spherical aberration is the predetermined value on the negative side is identical to the second position.

7. The optical pickup apparatus according to claim 1, wherein
the aberration correcting device includes a motor for moving the collimating lens in the optical axis direction.

8. The optical pickup apparatus according to claim 7, wherein
the motor includes a stepping motor; and
a rotation amount of the stepping motor is set by the number of driving pulses corresponding to an amount of moving the collimating lens in the optical axis direction.

9. The optical pickup apparatus according to claim 1, wherein
the aberration correcting device moves the collimating lens to an operation start position determined according to a jitter value included in a signal read from the signal recording layer of the optical disc, before the operation of reproducing a signal from the signal recording layer of the optical disc is started.

10. The optical pickup apparatus according to claim 9, wherein
the operation start position is a position at which the jitter value is a minimum.

11. The optical pickup apparatus according to claim 1, wherein
the aberration correcting device moves the collimating lens to an operation start position determined according to an RF signal read from the signal recording layer of the optical disc, before the operation of reproducing a signal from the signal recording layer of the optical disc is started.

12. The optical pickup apparatus according to claim 11, wherein
the operation start position is a position at which the RF signal is a maximum.
